(19) United States
(12) Patent Application Publication
(10) Pub. No.: US 2024/0317027 A1
(43) Pub. Date: Sep. 26, 2024

(54) VEHICLE

(71) Applicant: HONDA MOTOR CO., LTD., Minato-ku, Tokyo (JP)

(72) Inventors: Eitaro MIYANARI, Tokyo (JP); Hiro TSUTSUMI, Tokyo (JP)

(21) Appl. No.: 18/402,073

(22) Filed: Jan. 2, 2024

(30) Foreign Application Priority Data
Mar. 24, 2023 (CN) 202310295169.3

(51) Int. Cl. B60J 1/00; B60J 1/20; B60R 1/24

(52) U.S. Cl. CPC B60J 1/002; B60J 1/2094; B60R 1/24

(57) ABSTRACT

A vehicle includes a front window, a camera disposed on a cabin side of the front window to capture an image of an external environment through the front window, and a heater for raising a temperature of an area of the front window including a region inside a field of view of the camera. The front window includes: a first window panel fitted into a window frame of a vehicle body; and a second window panel formed as a separate member from the first window panel and disposed in the area including the region inside the field of view of the camera. A heat insulation member is disposed between the first window panel and the second window panel.

### TECHNICAL FIELD

The present invention relates to a vehicle provided with a camera disposed on a cabin side of a front window to capture an image of an external environment through the front window and a heater for raising the temperature of an area of the front window including a region inside the field of view of the camera.

### BACKGROUND ART

In recent years, efforts have been made to provide access to sustainable transportation systems that take into account in vulnerable situations among traffic participants. To achieve this, research and development are focused on further improving the safety and convenience of traffic through research and development related to preventive safety technology.

Some vehicles are provided with a camera to capture an image of an area in front of the vehicle for purposes such as external environment recognition for driving assistance. JP2022-155823A discloses a technology in which a camera is disposed on a cabin side of an upper portion of the front window to capture an image of an external environment through the front window. In this technology, in order to suppress fogging in a region of the front window inside the field of view of the camera, a heater for raising the temperature of the region inside the field of view of the camera is provided.

When the temperature outside the vehicle is low, fog appears on the front window, and when the temperature outside the vehicle gets even lower, icing occurs on the front window. The icing can cause distortion in the captured image obtained by the camera and lower the accuracy of external environment recognition based on the captured image obtained by the camera. Therefore, when icing occurred on the front window, it is desired to melt the ice promptly. However, if the temperature in the region of the front window inside the field of view of the camera is raised sharply by the heater to improve the ice melting performance, a temperature difference inside the front window may become significant so that the front window may be fractured.

### SUMMARY OF THE INVENTION

In view of such background, a primary object of the present invention is to provide a vehicle in which, even when the temperature in the region of the front window inside the field of view of the camera is raised in a short time, fracture of the front window due to the temperature difference can be avoided, whereby high ice melting performance can be achieved. Also, the present invention aims to improve the vehicle control stability by achieving high ice melting performance at the front window, thereby further improving the traffic safety and contributing to the development of a sustainable transportation system.

To achieve the above object, one aspect of the present invention provides a vehicle, comprising a front window (4), a camera (5) disposed on a cabin side of the front window (4) to capture an image of an external environment through the front window, and a heater (31, 32) for raising a temperature of an area of the front window including a region inside a field of view of the camera, wherein the front window comprises: a first window panel (11) fitted into a window frame of a vehicle body; and a second window panel (12) formed as a separate member from the first window panel and disposed in the area including the region inside the field of view of the camera, and wherein a heat insulation member (24) is disposed between the first window panel and the second window panel.

According to this aspect, even when the temperature of the second window panel is raised sharply by the heater, a significant temperature difference does not occur in the first window panel because heat is difficult to transfer from the second window panel to the first window panel. Therefore, it is possible to raise the temperature of the second window panel promptly and achieve high ice melting performance while avoiding fracture of the first window panel due to the temperature difference.

Preferably, the heater is disposed to surround a region of the second window panel inside the field of view of the camera.

According to this aspect, it is possible to prevent a large thermal distortion from occurring in the region of the second window panel inside the field of view of the camera, and thus, it is possible to effectively suppress occurrence of distortion in the captured image obtained by the camera. Consequently, the heater can be operated even when the vehicle is traveling.

Alternatively, the heater may be disposed on a region of the second window panel inside the field of view of the camera.

According to this aspect, it is possible to efficiently raise the temperature of the region of the second window panel inside the field of view of the camera, and thus, high ice melting performance can be realized. In this case, an electric heating wire may be disposed to cross the region inside the field of view of the camera. Also, a transparent film heater may be disposed within the region inside the field of view of the camera.

Preferably, the vehicle further comprises a holding member (7) that holds the camera to fix the camera to the vehicle body, wherein the heater is disposed on the holding member.

According to this aspect, it is possible to adopt a heater with high durability and thereby extend the lifespan. Also, it is possible to improve the degree of freedom of arrangement of the heater. Note that the holding member may be supported on only the front window, or may be supported on the roof part of the vehicle body in addition to the front window.

Preferably, the vehicle further comprises a holding member (7) that holds the camera to fix the camera to the vehicle body, wherein the second window panel is united with the first window panel together with the holding member.

According to this aspect, the second window panel can be properly fixed to the first window panel and the vehicle body together with the camera.

Preferably, the holding member is fixed to both of the first window panel and the second window panel.

According to this aspect, the second window panel can be stably fixed to the first window panel and the vehicle body together with the camera.

Preferably, the holding member is fixed to the second window panel, and is fixed to the first window panel via the second window panel.

According to this aspect, the second window panel can be easily assembled to the first window panel and the vehicle body together with the camera. In this case, the holding member may be fixed to the roof part of the vehicle body.

Preferably, the vehicle comprises, as the holding member, a first holding member (51) fixed to the first window panel and a second holding member (52) fixed to the second window panel, wherein the first holding member and the second holding member are joined and fixed to each other so that the first window panel and the second window panel are united with each other.

According to this aspect, the second window panel can be stably fixed to the first window panel and the vehicle body together with the camera.

Preferably, light shielding layers (15, 16) are formed on a part of the first window panel adjacent to the second window panel and a part of the second window panel excluding the region inside the field of view.

According to this aspect, since the area around the connection part between the first window panel and the second window panel is covered with the light shielding layer, the connection part between the first window panel and the second window panel is inconspicuous. Note that the light shielding layer may be made of black ceramic, for example.

According to the foregoing configuration, even when the temperature of the second window panel is raised sharply by the heater, a significant temperature difference does not occur in the first window panel because heat is difficult to transfer from the second window panel to the first window panel. Therefore, it is possible to raise the temperature of the second window panel promptly and achieve high ice melting performance while avoiding fracture of the first window panel due to the temperature difference.

### BRIEF DESCRIPTION OF THE DRAWINGS

FIG. 1 is a side view showing a front portion of a vehicle according to the first embodiment;

FIG. 2 is a perspective view showing the front portion of the vehicle according to the first embodiment;

FIG. 3 is a front view showing a main part of a front window of the vehicle according to the first embodiment;

FIGS. 4A and 4B are sectional views showing a main part of the front window of the vehicle according to the first embodiment when completed and during assembly, respectively;

FIG. 5 is a front view showing a main part of the front window of the vehicle according to the first modification of the first embodiment;

FIG. 6 is a front view showing a main part of the front window of the vehicle according to the second modification of the first embodiment;

FIG. 7 is a sectional view showing a main part of the front window of the vehicle according to the third modification of the first embodiment;

FIG. 8 is a front view showing a main part of the front window of the vehicle according to the second embodiment;

FIGS. 9A and 9B are sectional views showing a main part of the front window of the vehicle according to the second embodiment when completed and during assembly, respectively;

FIG. 10 is a front view showing a main part of the front window of the vehicle according to the third embodiment; and

FIGS. 11A and 11B are sectional views showing a main part of the front window of the vehicle according to the third embodiment when completed and during assembly, respectively.

### DETAILED DESCRIPTION OF THE INVENTION

### First Embodiment

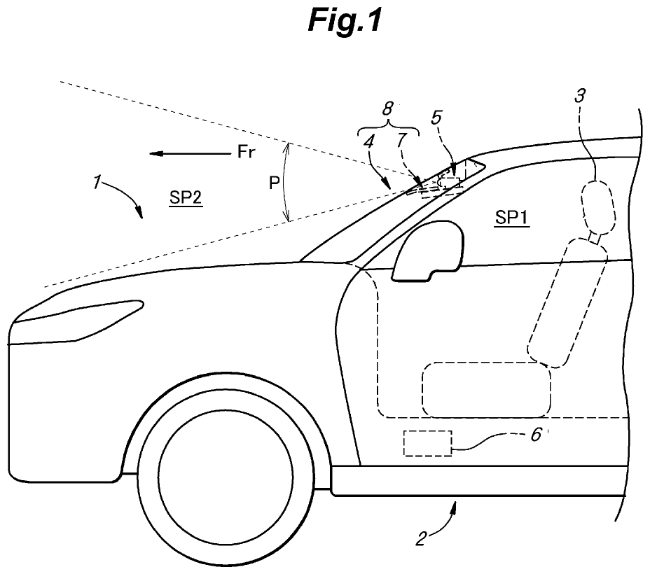

In the following, a first embodiment of the present invention will be described with reference to FIGS. 1 to 4B. The arrow Fr in FIG. 1 indicates the forward direction of the vehicle 1.

As shown in FIG. 1, the vehicle 1 is a four-wheeled automobile. The vehicle 1 includes a vehicle body 2 elongated in the front-rear direction. A vehicle interior space SP1 is defined inside the vehicle body 2, and multiple seats 3 are provided in a central part of the vehicle interior space SP1 in the front-rear direction.

In a front portion of the vehicle 1, a front window 4 (an example of a window) is provided in front of the multiple seats 3. The front window 4 partitions the vehicle interior space SP1 from a vehicle exterior space SP2 (in the present embodiment, the space in front of the vehicle 1). The front window 4 is inclined rearward toward the top.

Behind an upper portion of the front window 4, a front camera 5 (an example of a vehicle-mounted camera) is provided. The front camera 5 captures an image of the vehicle exterior space SP2 (external environment) from the side of the vehicle interior space SP1 (cabin) through the front window 4. For example, the front camera 5 is a digital camera using a solid imaging element such as a CCD or CMOS. The front camera 5 is connected to a controller 6. The controller 6 is configured to perform advanced driver assistance control (for example, lane keeping control or preceding vehicle following control) of the vehicle 1 based on the image data transmitted from the front camera 5.

The controller 6 performs external environment recognition to recognize the positions of objects present in the vehicle exterior space SP2 (for example, obstacles and delimiting lines on the traveling path of the vehicle 1) based on the detection result of an external environment sensor such as the front camera 5. For example, the controller 6 recognizes the positions of the objects present in front of the vehicle 1 by analyzing the change in the density value on the image captured by the front camera 5.

A bracket 7 (an example of a holding member) for holding the front camera 5 is fixed to the inner surface (namely, the surface on the side of the vehicle interior space SP1) of the front window 4. The bracket 7 constitutes a camera holding structure 8 jointly with the front window 4. Note that an arrow P in FIG. 1 indicates the range of the field of view (image capturing range) of the front camera 5.

When the temperature outside the vehicle is low, fog appears on the front window 4, and when the temperature outside the vehicle gets even lower, icing occurs on the front window 4. The icing can cause distortion in the captured image obtained by the front camera 5 and lower the accuracy of the external environment recognition based on the captured image obtained by the front camera 5. Therefore, when icing occurred on the front window 4, it is desired to melt the ice promptly. However, if the temperature in the region of the front window 4 inside the field of view of the front camera 5 is raised sharply in order to improve the ice melting performance, a temperature difference inside the front window 4 may become significant so that the front window 4 may be fractured.

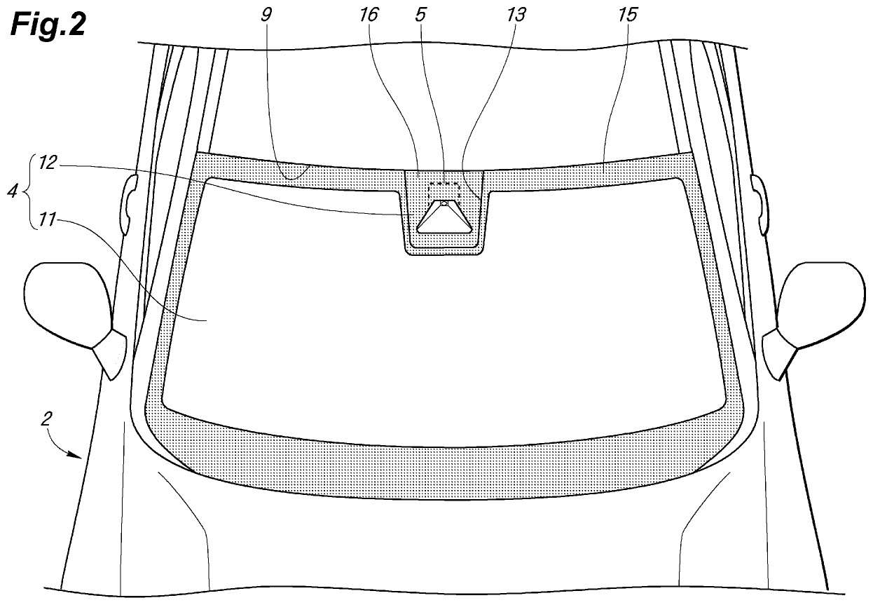

To solve such a problem, in the present embodiment, as shown in FIG. 2, the front window 4 is configured to include a first window panel 11 fitted into a window frame 9 (frame) of the vehicle body 2 and a second window panel 12 formed as a separate member from the first window panel 11 and disposed in an area including the region inside the field of view of the front camera 5. The first window panel 11 is formed with a recessed part 13 in the area including the region inside the field of view of the front camera 5, and the second window panel 12 is provided to fill the recessed part 13. Thereby, it is possible to raise the temperature of the second window panel 12 promptly and achieve high ice melting performance, while avoiding fracture of the first window panel 11 due to the temperature difference.

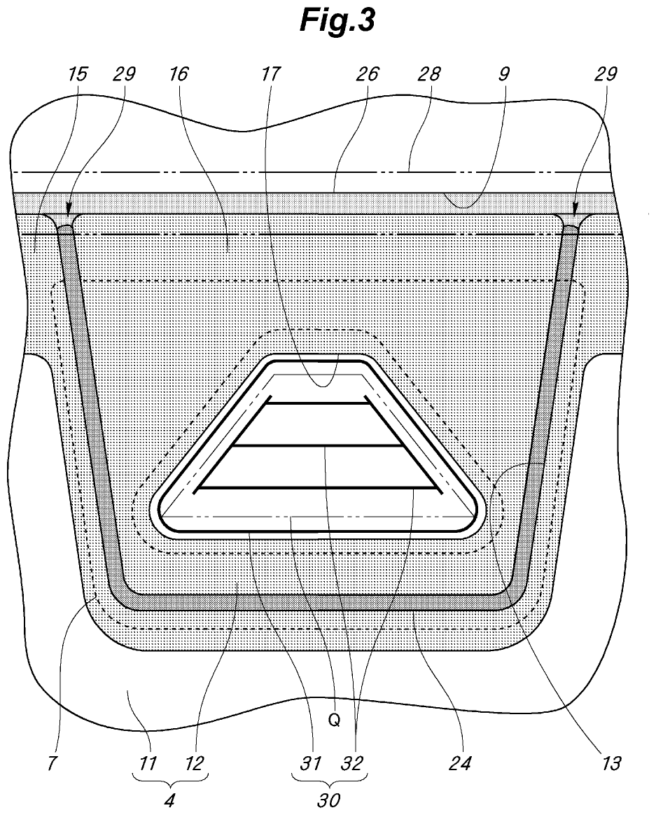

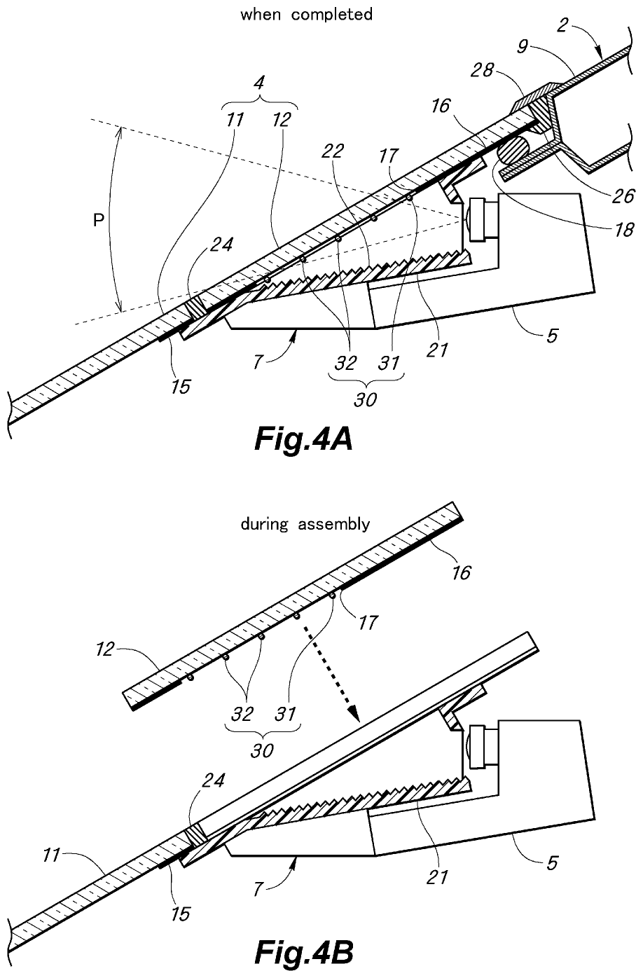

As shown in FIGS. 3 and 4A, the bracket 7 holds the front camera 5 and fixes the front camera 5 to the vehicle body 2. The bracket 7 is fixed to the inner surfaces of both of the first window panel 11 and the second window panel 12.

As shown in FIG. 4B, at the time of assembly, first, the bracket 7 is fixed to the inner surface of the first window panel 11, and then the second window panel 12 is fixed to the first window panel 11 and the bracket 7 which are united with each other. At this time, the bracket 7 may be fixed to the first window panel 11 and the second window panel 12 with an adhesive agent, for example. Thereby, the second window panel 12 is united with the first window panel 11 together with the bracket 7.

As shown in FIG. 4A, the bracket 7 includes a hood part 21 defining the range P of the field of view of the front camera 5. The hood part 21 is provided with a stray light suppression structure 22 (also referred to as a stray light shield (SLS)) for suppressing the stray light (reflection light) entering the lens of the front camera 5. The stray light suppression structure 22 is composed of multiple ridges arranged continuously in the front-rear direction, for example. Each ridge has an inverted V-shaped cross section and extends linearly in the left-right direction, for example.

As shown in FIG. 2, the first window panel 11 is formed with a light shielding layer 15 on the inner surface of an outer peripheral portion thereof. Also, as shown in FIG. 3, the light shielding layer 15 is formed to cover a part of the first window panel 11 adjacent to the second window panel 12. On the other hand, the second window panel 12 is formed with a light shielding layer 16 on the inner surface of a part thereof excluding the region inside the field of view of the front camera 5. The light shielding layer 16 formed on the second window panel 12 is formed with a trapezoidal opening 17 in the region inside the field of view of the front camera 5.

As shown in FIGS. 4A and 4B, the light shielding layer 15 has a role of protecting a sealer 18 (adhesive agent) for fixing the first window panel 11 to the window frame 9 against ultraviolet light from outside the vehicle and thereby enhancing the durability of the sealer 18 and a role of hiding the sealer 18 so as not to be viewed from outside the vehicle and thereby enhancing the aesthetic appearance. Also, since the area around the connection part between the first window panel 11 and the second window panel 12 is covered with the light shielding layers 15, 16, the connection part between the first window panel 11 and the second window panel 12 is inconspicuous.

The bracket 7 is fixed to the part of the first window panel 11 where the light shielding layer 15 is formed and to the part of the second window panel 12 where the light shielding layer 16 is formed. Thus, the parts where the bracket 7 is fixed to the first window panel 11 and the second window panel 12 are covered by the light shielding layers 15, 16 and are not viewable from outside the vehicle, and this also contributes to enhancing the aesthetic appearance. Note that an adhesive agent may be used to fix the bracket 7.

Note that the light shielding layers 15, 16 may be formed by printing black ceramic, for example. Also, the light shielding layers 15, 16 may be formed as a laminate structure in which a black ceramic layer is sandwiched by two sheets of glass, for example.

Here, it is to be noted that when manufacturing the front window 4, the temperature of the parts where the light shielding layers 15, 16 are formed is lowered more quickly compared to the parts where the light shielding layers 15, 16 are not formed, and this can cause a distortion in the trapezoidal opening 17. This distortion can affect the external environment recognition based on the captured image obtained by the front camera 5, and thus, difficult temperature management is necessary to reduce the distortion. On the other hand, in the present embodiment, since the second window panel 12, which has the opening 17 formed in the light shielding layer 16, is a separate member from the first window panel 11, the difficulty in the temperature management is alleviated.

As shown in FIG. 3, the front window 4 is provided with a heating device 30. The heating device 30 heats the front window 4 thereby to suppress fogging of the front window 4 and to melt the ice on the front window 4. The heating device 30 includes a first heater 31 and a second heater 32.

As shown in FIG. 4A, the first heater 31 and the second heater 32 are provided on the inner surface of the second window panel 12. The first heater 31 is disposed outside the region inside the field of view of the front camera 5. The first heater 31 includes an annular electric heating wire surrounding the region inside the field of view of the front camera 5. The second heater 32 is disposed within the region inside the field of view of the front camera 5. The second heater 32 includes an electric heating wire crossing the region inside the field of view of the front camera 5. Note that a broken line frame Q in FIG. 3 indicates the region of the second window panel 12 inside the field of view of the front camera 5.

The first heater 31 and the second heater 32 may form a laminate structure in which the electric heating wires are sandwiched by two sheets of glass constituting the second window panel 12. Alternatively, the first heater 31 and the second heater 32 may form a structure in which the electric heating wires are formed by printing on a glass base material constituting the second window panel 12.

The first heater 31 and the second heater 32 are in contact with the second window panel 12 and directly heat the second window panel 12. Therefore, it is possible to rapidly raise the temperature the second window panel 12 to promptly melt the ice on the second window panel 12. This also contributes to reducing the electric power consumption.

The controller 6 controls the heating device 30 based on the detection result of a temperature sensor (not shown in the drawings) provided on the vehicle 1. A defogging condition and a deicing condition related to the temperature outside the vehicle, the temperature inside the vehicle, the temperature in the front camera 5, etc. are set beforehand, and when the defogging condition is satisfied, the heating device 30 is controlled to defog the second window panel 12. When the deicing condition is met, the heating device 30 is controlled to melt the ice on the second window panel 12.

Also, by operating the first heater 31 and the second heater 32 when the vehicle 1 is stopped, it is possible to effectively defog and deice (melt the ice on) the second window panel 12. On the other hand, by operating only the first heater 31 when the vehicle 1 is traveling, it is possible to reduce thermal distortion of the second window panel 12 thereby to effectively suppress occurrence of distortion in the captured image obtained by the front camera 5.

As shown in FIG. 3, a heat insulation member 24 is disposed between the first window panel 11 and the second window panel 12. The heat insulation member 24 is pre-molded into a shape suitable for closing the gap between the periphery of the recessed part 13 of the first window panel 11 and the periphery of the outer circumference of the second window panel 12, and is inserted between the first window panel 11 and the second window panel 12 during assembly.

The heat insulation member 24 is made of a material having a low thermal conductivity. Also, the heat insulation member 24 is made of a material having a large heat capacity. Specifically, the heat insulation member 24 may be made of a synthetic resin material having a low thermal conductivity, such as polycarbonate, for example. Also, the heat insulation member 24 may be made of a rubber material having a low thermal conductivity. The synthetic resin material, such as polycarbonate, and the rubber material have a thermal conductivity lower than that of soda glass used in the first window panel 11 and the second window panel 12. Therefore, heat is difficult to transfer from the second window panel 12 to the first window panel 11.

Note that inorganic glass other than soda glass may be used as the base material of the first window panel 11 and the second window panel 12.

In a case where the heat insulation member 24 is made of a rigid material, such as polycarbonate, for example, a filling member (not shown in the drawings) made of highly flexible, elastic material (for example, rubber material) may be provided between the heat insulation member 24 and each of the first window panel 11 and the second window panel 12 to allow deformation of the first window panel 11 and the second window panel 12 due to temperature change, etc.

As shown in FIG. 3, the upper edge of the second window panel 12 is fixed to the window frame 9 similarly to the upper edge of the first window panel 11. A window molding 26 is provided between the window frame 9 and the first window panel 11 and between the window frame 9 and the second window panel 12. The window molding 26 is pre-molded from rubber material and is interposed between the window frame 9 and the first window panel 11 and between the window frame 9 and the second window panel 12 during assembly. Note that as shown in FIG. 4A, the first window panel 11 and the second window panel 12 are fixed to the window frame 9 by the sealer 18.

As shown in FIG. 3, a garnish 28 is provided on the upper edges of the first window panel 11 and the second window panel 12. Each corner part of the first window panel 11 and the second window panel 12 is chamfered with a predetermined radius. As a result, a gap 29 is formed at each upper end of the connection part between the first window panel 11 and the second window panel 12. The garnish 28 mounted to close the gaps 29 from outer side can prevent intrusion of foreign matters such as water. Note that the upper edge parts of the first window panel 11 and the second window panel 12 may be inserted into the window frame 9 to hide the gaps 29.

### First Modification

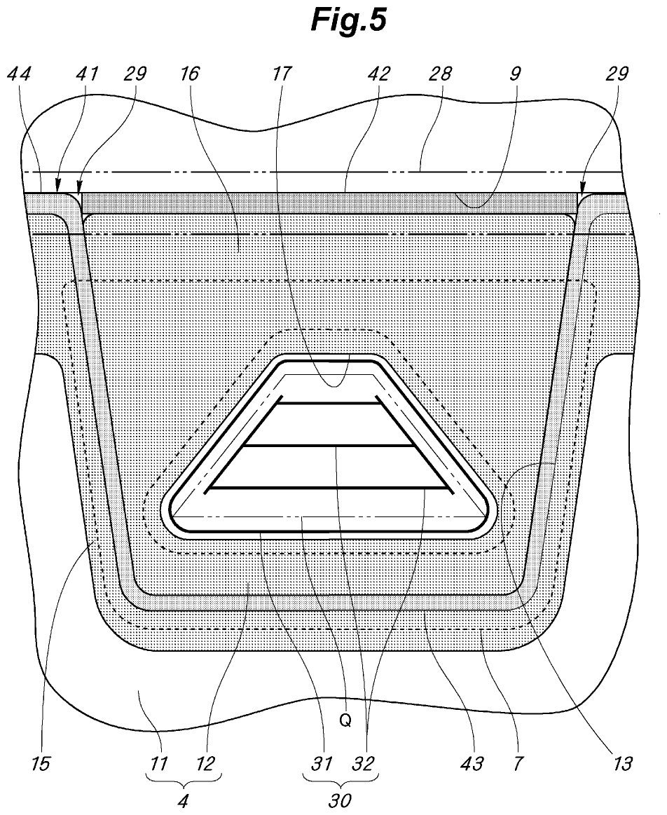

As shown in FIG. 5, in the first modification, a first window molding 41 and a second window molding 42 are provided. Similarly to the window molding 26 of the first embodiment (see FIG. 3), the first window molding 41 is provided between the first window panel 11 and the window frame 9 (frame). The second window molding 42 is provided between the second window panel 12 and the window frame 9.

The first window molding 41 also functions as the heat insulation member 24 (see FIG. 3) of the first embodiment. Namely, the first window molding 41 is integrally formed with a U-shaped heat insulation part 43 that is interposed between the first window panel 11 and the second window panel 12. The first window molding 41 is pre-molded from rubber material into a predetermined shape, and is inserted between the first window panel 11 and the window frame 9 during assembly, except that the heat insulation part 43 is interposed between the first window panel 11 and the second window panel 12. The heat insulation part 43 may be fixed to the first window panel 11 and the second window panel 12 with an adhesive agent, for example.

In the first window molding 41, a part 44 interposed between the first window panel 11 and the window frame 9 and the U-shaped heat insulation part 43 interposed between the first window panel 11 and the second window panel 12 are integrally formed, whereby the sealability (waterproofness), etc. can be improved. Note that the first window molding 41 is made of highly flexible rubber material having a thermal conductivity lower than that of inorganic glass such as soda glass used as the base material of the first window panel 11 and the second window panel 12.

Note that a gap 29 is formed at each upper end of the connection part between the first window panel 11 and the second window panel 12, but similarly to the first embodiment (see FIG. 3), the garnish 28 mounted to close the gaps 29 from outer side can prevent intrusion of foreign matters such as water. Also, the upper edge parts of the first window panel 11 and the second window panel 12 may be inserted into the window frame 9 to hide the gaps 29.

### Second Modification

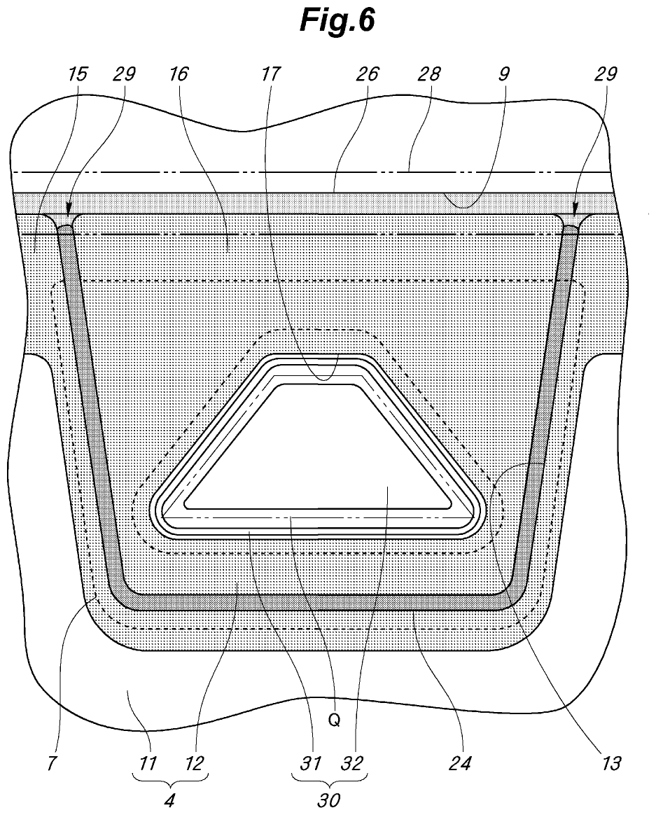

As shown in FIG. 6, in the second modification, the first heater 31 disposed outside the region inside the field of view of the front camera 5 and the second heater 32 disposed within the region inside the field of view of the front camera 5 are provided similarly to the first embodiment (see FIGS. 3 to 4B). The first heater 31 and the second heater 32 are provided on the inner surface of the second window panel 12. The first heater 31 and the second heater 32 are composed of transparent film heaters. For example, each of the first heater 31 and the second heater 32 may be composed of a film heater having a transparent conductive membrane made of ITO (Indium Tin Oxide).

### Third Modification

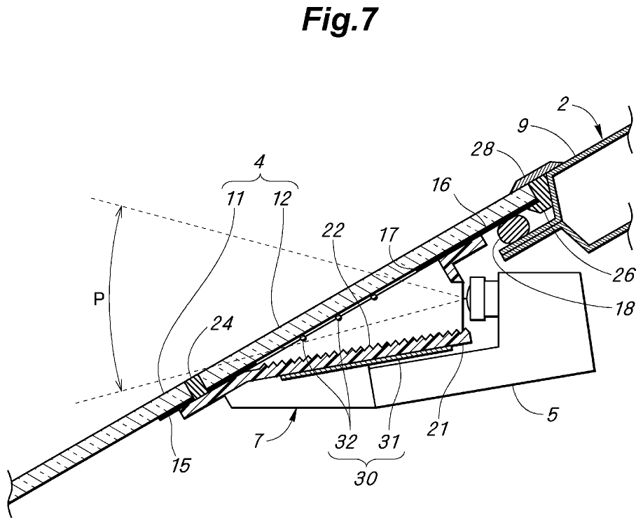

As shown in FIG. 7, in the third modification, the first heater 31 disposed outside the region inside the field of view of the front camera 5 and the second heater 32 disposed within the region inside the field of view of the front camera 5 are provided similarly to the first embodiment (see FIGS. 3 to 4B). Similarly to the first embodiment, the second heater 32 is provided on the inner surface of the second window panel 12.

On the other hand, the first heater 31 is disposed on the bracket 7. The first heater 31 is mounted on the lower surface of the hood part 21 of the bracket 7. The first heater 31 is not in contact with the second window panel 12, and indirectly heats the second window panel 12. The first heater 31 is composed of a film heater, for example. For example, the first heater 31 may be a film heater having an electric heating wire (heater circuit) formed on one surface of a film by printing or the like, or may be a film heater having a laminate structure in which an electric heating wire is sandwiched by two films. Thereby, the durability of the first heater 31 is improved and the lifespan can be extended. Also, the degree of freedom of arrangement of the first heater 31 is improved.

Note that various forms of the heating device 30 for heating the second window panel 12 have been shown in the first embodiment and its modifications, but the heating device 30 is not limited to these forms.

### Second Embodiment

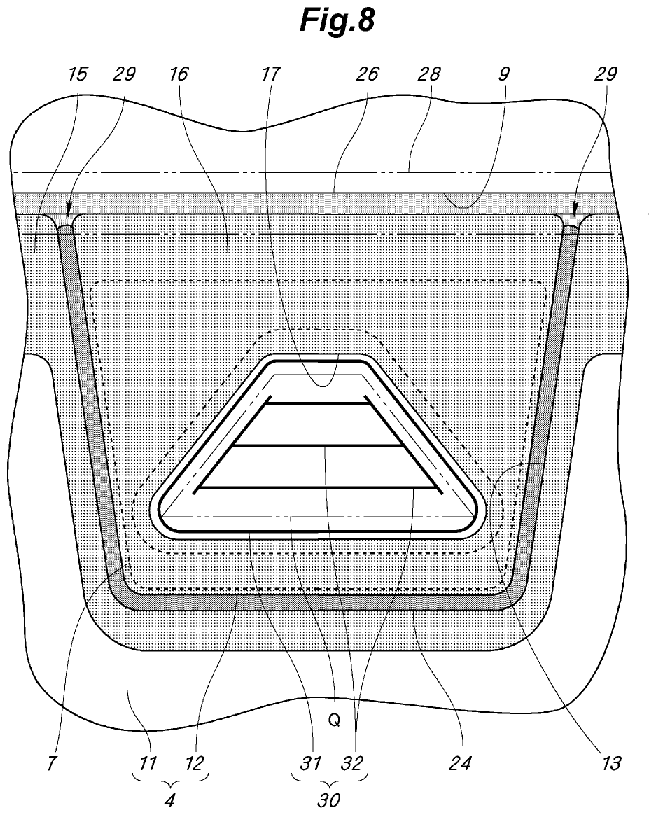

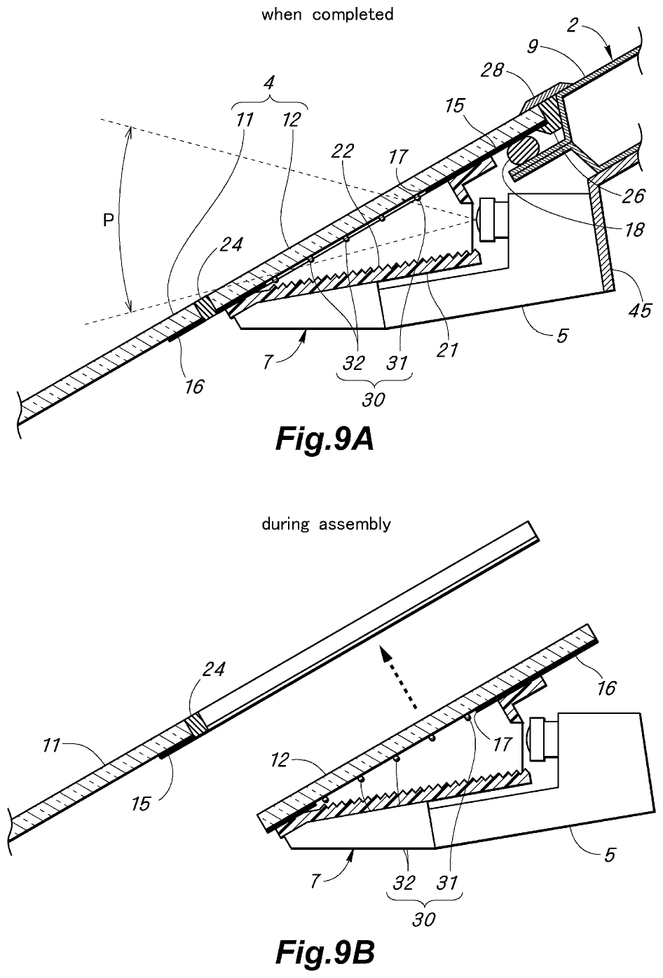

Next, with reference to FIGS. 8 to 9B, a second embodiment of the present invention will be described.

As shown in FIGS. 8 and 9A, in this embodiment, the bracket 7 is fixed to the second window panel 12, and is fixed to the first window panel 11 via the second window panel 12. As shown in FIG. 9B, at the time of assembly, first, the bracket 7 is fixed to the second window panel 12, and then the second window panel 12 and the bracket 7 which are united with each other are fixed to the first window panel 11. At this time, the bracket 7 may be fixed to the second window panel 12 with an adhesive agent, for example.

Also, in the example shown in FIG. 9A, the bracket 7 is fixed to the roof part of the vehicle body 2 via a stay 45. Note that the shape of the stay 45 is only one example, and the stay 45 is not limited to such a shape.

Note that in this embodiment, the bracket 7 is not fixed to the first window panel 11 and is fixed to the second window panel 12, but configuration may be made such that when the second window panel 12 is assembled with the first window panel 11 after the bracket 7 is fixed to the second window panel 12, the bracket 7 is fixed to the first window panel 11.

### Third Embodiment

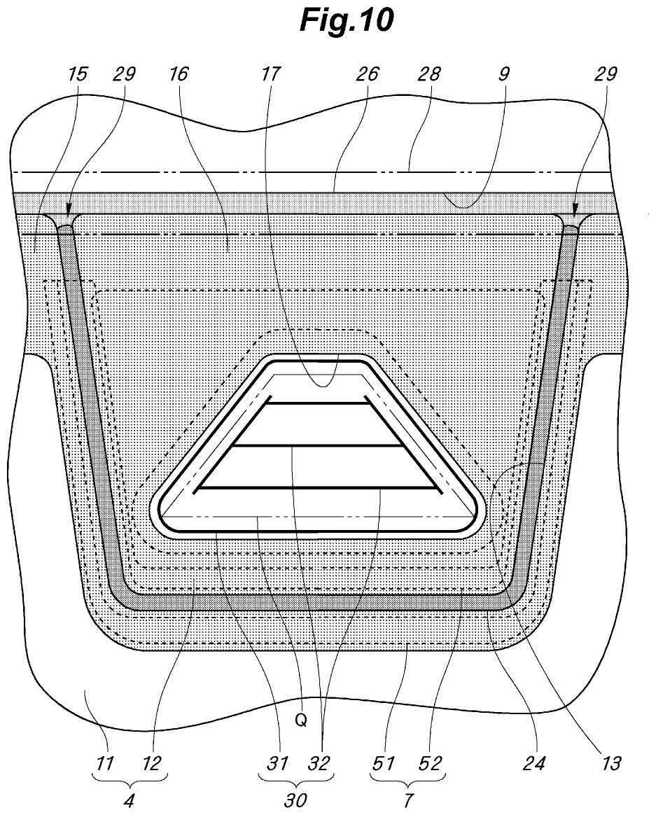

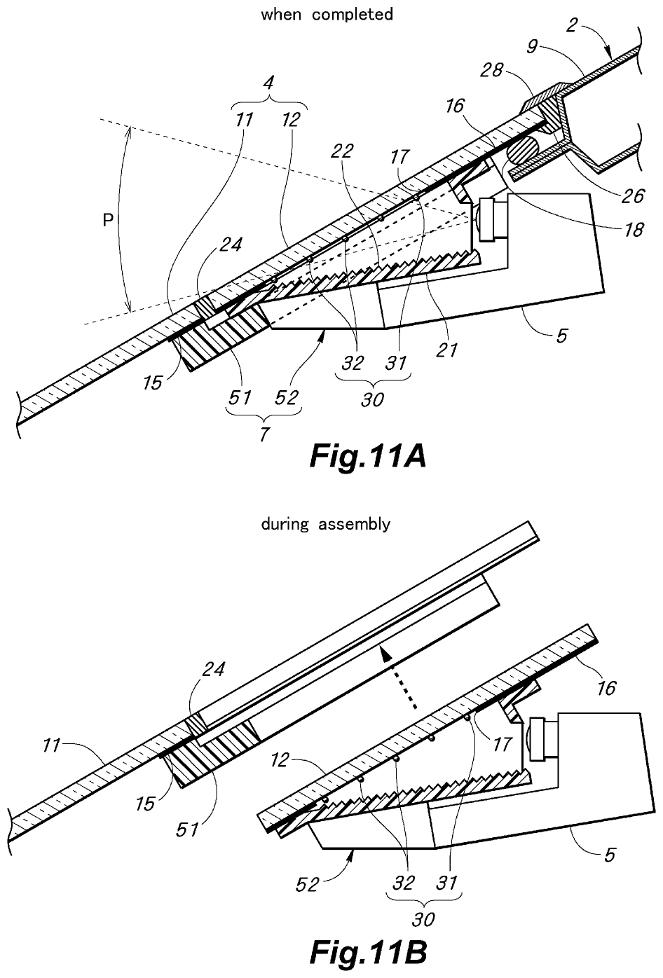

Next, with reference to FIGS. 10 to 11B, a third embodiment of the present invention will be described.

As shown in FIGS. 10 to 11B, in this embodiment, the bracket 7 is composed of a first bracket 51 (an example of a first holding member) and a second bracket 52 (an example of a second holding member). The first bracket 51 is fixed to the inner surface of the first window panel 11. The second bracket 52 is fixed to the inner surface of the second window panel 12. The first bracket 51 and the second bracket 52 are fixed to each other. With the first bracket 51 and the second bracket 52 fixed to each other, the first window panel 11 and the second window panel 12 are united with each other.

Here, the first bracket 51 and the second bracket 52 may be fixed to each other by mutually fitted structures, for example. Also, the first bracket 51 and the second bracket 52 may be fixed to the inner surface of the first window panel 11 and the inner surface of the second window panel 12, respectively, by using an adhesive agent, for example.

Note that the shapes of the first bracket 51 and the second bracket 52 shown in FIGS. 10, 11A, and 11B are only one example, and the first bracket 51 and the second bracket 52 are not limited to them.

Concrete embodiments of the present invention have been described in the foregoing, but the present invention is not limited to the above embodiments, and various modifications and alterations are possible.

1. A vehicle, comprising a front window, a camera disposed on a cabin side of the front window to capture an image of an external environment through the front window, and a heater for raising a temperature of an area of the front window including a region inside a field of view of the camera,
wherein the front window comprises:
a first window panel fitted into a window frame of a vehicle body; and
a second window panel formed as a separate member from the first window panel and disposed in the area including the region inside the field of view of the camera,
and wherein a heat insulation member is disposed between the first window panel and the second window panel.

2. The vehicle according to claim 1, wherein the heater is disposed to surround a region of the second window panel inside the field of view of the camera.

3. The vehicle according to claim 1, wherein the heater is disposed on a region of the second window panel inside the field of view of the camera.

4. The vehicle according to claim 1, further comprising a holding member that holds the camera to fix the camera to the vehicle body,
wherein the heater is disposed on the holding member.

5. The vehicle according to claim 1, further comprising a holding member that holds the camera to fix the camera to the vehicle body,
wherein the second window panel is united with the first window panel together with the holding member.

6. The vehicle according to claim 5, wherein the holding member is fixed to both of the first window panel and the second window panel.

7. The vehicle according to claim 5, wherein the holding member is fixed to the second window panel, and is fixed to the first window panel via the second window panel.

8. The vehicle according to claim 5, comprising, as the holding member, a first holding member fixed to the first window panel and a second holding member fixed to the second window panel,
wherein the first holding member and the second holding member are joined and fixed to each other so that the first window panel and the second window panel are united with each other.

9. The vehicle according to claim 1, wherein light shielding layers are formed on a part of the first window panel adjacent to the second window panel and a part of the second window panel excluding the region inside the field of view.
